(19) United States
(12) Patent Application Publication
(10) Pub. No.: US 2025/0083391 A1
(43) Pub. Date: Mar. 13, 2025

(54) SYSTEM AND METHOD FOR PRINTING A TEXTURED THREE-DIMENSIONAL OBJECT

(71) Applicant: STRATASYS LTD., Rehovot (IL)

(72) Inventors: Shai WAISEL, Petach Tikva (IL); Naftali Emanuel EDER, Kiryat Gat (IL); Yosef MELLER, Even Yehuda (IL)

(73) Assignee: STRATASYS LTD., Rehovot (IL)

(21) Appl. No.: 18/724,969

(22) PCT Filed: Dec. 20, 2022
(86) PCT No.: PCT/IL2022/051353

§ 371 Date: Jun. 27, 2024

Related U.S. Application Data
(60) Provisional application No. 63/295,009, filed on Dec. 30, 2021.

(51) Int. Cl. B29C 64/386; B33Y 10/00; B33Y 30/00; B33Y 50/00

(52) U.S. Cl. CPC B29C 64/386; B33Y 10/00; B33Y 30/00; B33Y 50/00

(57) ABSTRACT

Systems and methods for printing a 3D object on a 3D printer, including: receiving (i) a digital 3D model comprising a 3D geometry of the 3D object, (ii) a 2D displacement map, (iii) one or more maximal displacement values, and (iv) a printing resolution, calculating a displacement limit for each vertex of the 3D model based on the one or more maximal displacement values, applying local tessellation on the 3D model geometry in accordance with the 2D displacement map and with the printing resolution, thereby obtaining a tessellated 3D model, applying the displacement information of the 2D displacement map to the tessellated 3D model in accordance with the calculated displacement limit relative to each vertex, thereby obtaining a displaced 3D model, and printing the 3D object with the 3D printer based on the displaced 3D model.

### FIELD OF THE INVENTION

The present invention relates to printing three-dimensional (3D) objects. More particularly, the present invention relates to systems and methods for printing textured 3D objects.

### BACKGROUND

In recent years, numerous technological advancements have become available in the field of three-dimensional (3D) inkjet printing. For 3D inkjet printing, building materials are selectively jetted from one or more print heads and dispensed onto a fabrication tray to form the 3D object, layer-by-layer, according to a pre-determined configuration as defined by a software file.

Building materials may be modeling materials, which are selectively dispensed to produce the 3D object, and support materials (also referred to as “supporting material”), which are selectively dispensed to form support constructions which sustain specific regions of the 3D object during the printing process.

For instance, a support construction may be necessary when the object includes negative angle surfaces, hollows and/or overhangs, and is typically configured to be removed after the printing is complete.

For printing of textured 3D objects, a texture map or bump image is generally used together with a 3D model of the object. Typically, the texture is a two-dimensional image where each pixel indicates a height/displacement value to be applied to the surface of the 3D model.

Displacement occurs across a wide range of heights from the original surface of the 3D model, where a height with a positive value may code for a “protruding” element while a height with a negative value may code for an “inward” element of the texture. If the texture map presents a lot of variations, for example a complex pattern of grey values in a grayscale map, physical heights may vary drastically and some surface modifications may result in a modified 3D model that does not fulfill the 3D printing requirements (e.g. not water-tight, intersection of surfaces, in fine elements of the 3D object, the surfaces may cross over the whole volume of the 3D model and appear on the opposite side).

It is therefore desirable to apply predefined rules and displacement values in order to print complex 3D objects with a desired texture.

### SUMMARY

There is thus provided, in accordance with some embodiments of the invention, a method of printing a 3D object on a 3D printer, including: receiving (i) a digital 3D model including a 3D geometry of the 3D object, the 3D geometry including a list of vertices and faces, (ii) a 2D displacement map including displacement information, (iii) one or more maximal displacement values, and (iv) a printing resolution of the 3D printer, calculating a displacement limit for each vertex of the 3D model based on the one or more maximal displacement values, applying local tessellation on the 3D model geometry in accordance with the 2D displacement map and with the printing resolution, thereby obtaining a tessellated 3D model, applying the displacement information of the 2D displacement map to the tessellated 3D model in accordance with the calculated displacement limit relative to each vertex, thereby obtaining a displaced 3D model, printing the 3D object with the 3D printer based on the displaced 3D model.

In some embodiments, the 3D geometry further includes color data expressed as color per vertex or by UV mapping on a texture map. In some embodiments, the 2D displacement map is an image including a series of pixels and where each vertex of the 3D model is associated with a pixel of the 2D displacement map.

In some embodiments, the 2D displacement map is a grayscale image including a maximum grayscale value and a minimum grayscale value, and where each pixel is allocated with a grayscale value included between the maximum and minimum grayscale values. In some embodiments, a mid-range grayscale value between the maximum grayscale value and the minimum grayscale value indicates no displacement. In some embodiments, the minimum grayscale value is 0 and the maximum grayscale value is 255. In some embodiments, a grayscale value of 127 indicates no displacement.

In some embodiments, the 2D displacement map is pre-processed by (i) finding the lowest and highest greyscale value pixel(s), (ii) setting the greyscale value of the lowest greyscale value pixel(s) to a minimum greyscale value, (iii) setting the greyscale value of the highest greyscale value pixel(s) to a maximum greyscale value, and (iv) re-calculating the greyscale value of the remaining pixels according to a proportional rule taking into consideration the maximum and minimum greyscale values.

In some embodiments, the minimum greyscale value is 0 and the maximum greyscale value is 255. In some embodiments, the one or more maximal displacement values includes a maximal inward displacement value and a maximal outward displacement value. In some embodiments, the maximal inward displacement value is of between 0 and 1 mm and the maximal outward displacement value is of between 0 and 1 mm.

In some embodiments, the printing resolution is provided as a number of pixels per unit of distance or a number of voxel per unit of distance. In some embodiments, applying local tessellation includes dividing faces of the 3D model geometry and increasing a local density of faces, and where at least an edge of each newly generated faces is longer than the diagonal of a pixel or voxel defined by the printing resolution.

In some embodiments, calculating a displacement limit for a vertex of the 3D model includes moving the vertex along its normal according to the one or more maximal displacement values. In some embodiments, the calculated displacement limit for a vertex of the 3D digital model is limited to the thickness of a nearby surrounding volume.

In some embodiments, applying the displacement information to the tessellated 3D model includes displacing a vertex of the tessellated 3D model along the vertex related normal by a distance defined by the 2D displacement map and limited by its calculated displacement limit. In some embodiments, local tessellating includes tessellating neighboring faces such that the vertices along their mutual edge match.

There is thus provided, in accordance with some embodiments of the invention, a system for printing a 3D object, the system including: a 3D printing device, including a printing resolution, and a processor, in communication with the 3D printing device, where the processor is configured to: receive (i) a digital 3D model including a 3D geometry of the 3D object, the 3D geometry including a list of vertices and faces, (ii) a 2D displacement map including displacement information, (iii) one or more maximal displacement values, and (iv) the printing resolution, calculate a displacement limit for each vertex of the 3D model based on the one or more maximal displacement values, apply local tessellation on the 3D model geometry in accordance with the 2D displacement map and with the printing resolution, thereby obtaining a tessellated 3D model, apply the displacement information of the 2D displacement map to the tessellated 3D model in accordance with the calculated displacement limit relative to each vertex, thereby obtaining a displaced 3D model, and print the 3D object with the 3D printer based on the displaced 3D model.

In some embodiments, the 2D displacement map is pre-processed by (i) finding the lowest and highest greyscale value pixel(s), (ii) setting the greyscale value of the lowest greyscale value pixel(s) to a minimum greyscale value, (iii) setting the greyscale value of the highest greyscale value pixel(s) to a maximum greyscale value, and (iv) re-calculating the greyscale value of the remaining pixels according to a proportional rule taking into consideration the maximum and minimum greyscale values. In some embodiments, calculation of a displacement limit for a vertex of the 3D model includes moving the vertex along its normal according to the one or more maximal displacement values.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows a block diagram of a computing device, according to some embodiments of the invention;

FIG. 2 illustrates displacement of a 3D model mesh of a 3D object, according to some embodiments of the invention;

FIG. 3 shows a block diagram of a system for printing a 3D object, according to some embodiments of the invention; and

FIGS. 4A-4B show a flowchart of a method of printing a 3D object on a 3D printer, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention.

Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items.

Unless explicitly stated, the method embodiments described herein are not constrained to a particular order or sequence. Additionally, some of the described method embodiments or elements thereof may occur or be performed simultaneously, at the same point in time, or concurrently.

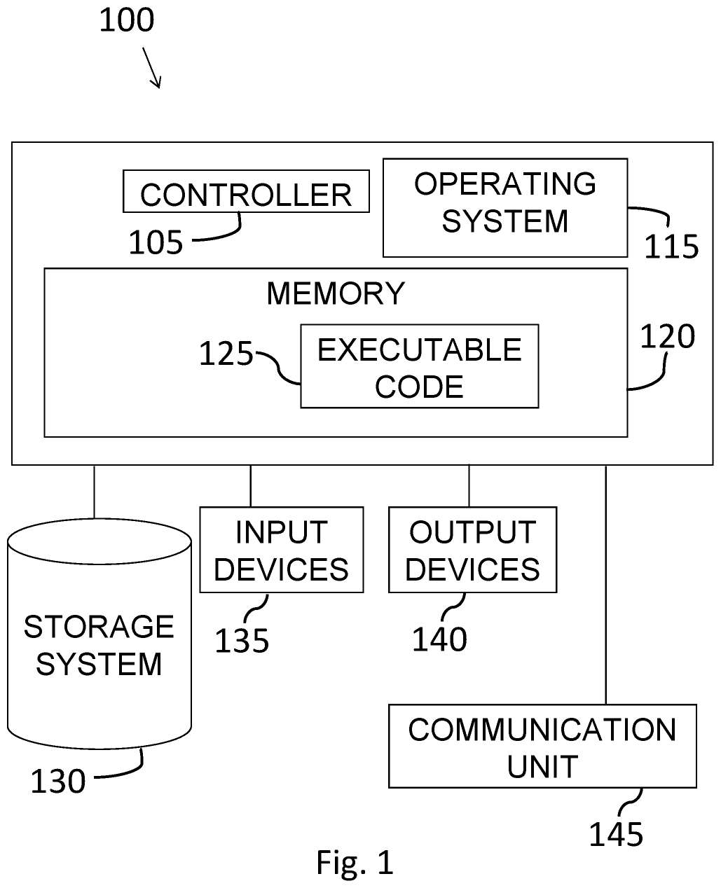

Reference is made to FIG. 1, which is a block diagram of an example computing device, according to some embodiments of the invention.

Computing device 100 may include a controller or processor 105 (e.g., a central processing unit processor (CPU), a chip or any suitable computing or computational device), an operating system 115, memory 120, executable code 125, storage 130, input devices 135 (e.g. a keyboard or touchscreen), and output devices 140 (e.g., a display), a communication unit 145 (e.g., a cellular transmitter or modem, a Wi-Fi communication unit, or the like) for communicating with remote devices via a communication network, such as, for example, the Internet.

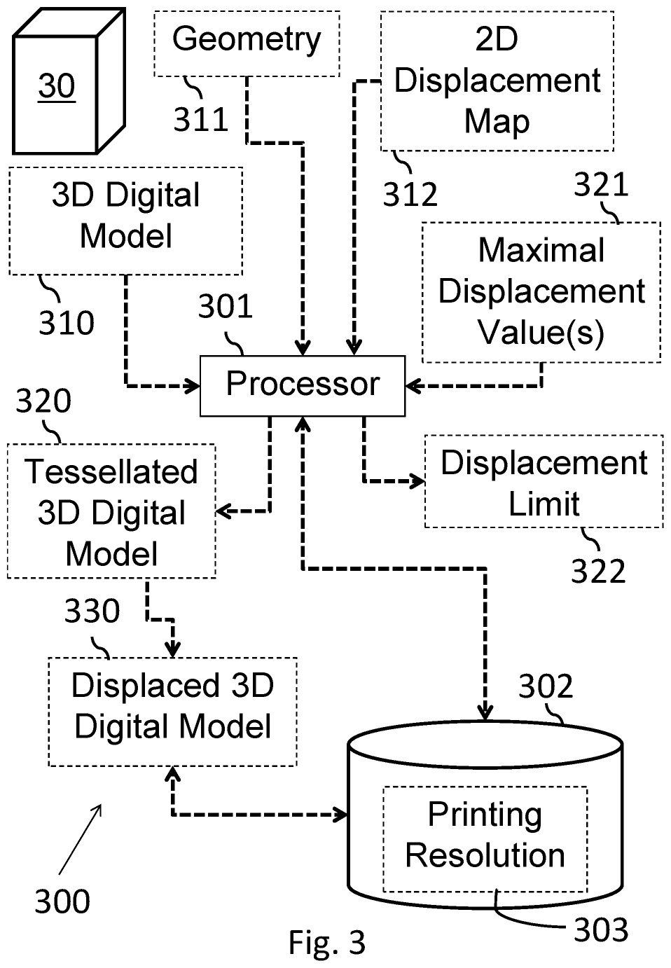

Controller 105 may be configured to execute program code to perform operations described herein. The system described herein may include one or more computing device(s) 100, for example, to act as the various devices or the components shown in FIG. 3. For example, controller 105 may be configured to communicate with a printing device that is connected to the controller 105.

Operating system 115 may be or may include any code segment (e.g., one similar to executable code 125 described herein) designed and/or configured to perform tasks involving coordinating, scheduling, arbitrating, supervising, controlling or otherwise managing operation of computing device 100, for example, scheduling execution of software programs or enabling software programs or other modules or units to communicate.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units.

Memory 120 may be or may include a plurality of similar and/or different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be a software application that performs methods as further described herein.

Although, for the sake of clarity, a single item of executable code 125 is shown in FIG. 1, a system according to embodiments of the invention may include a plurality of executable code segments similar to executable code 125 that may be stored into memory 120 and cause controller 105 to carry out methods described herein.

Storage 130 may be or may include, for example, a hard disk drive, a universal serial bus (USB) device or other suitable removable and/or fixed storage unit. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a keyboard, a touch screen or pad, one or more sensors or any other or additional suitable input device. Any suitable number of input devices 135 may be operatively connected to computing device 100. Output devices 140 may include one or more displays or monitors and/or any other suitable output devices.

Any suitable number of output devices 140 may be operatively connected to computing device 100. Any applicable input/output (I/O) devices may be connected to computing device 100 as shown by blocks 135 and 140. For example, a wired or wireless network interface card (NIC), a universal serial bus (USB) device or external hard drive may be included in input devices 135 and/or output devices 140.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

For example, an article may include a storage medium such as memory 120, computer-executable instructions such as executable code 125 and a controller such as controller 105. Such a non-transitory computer readable medium may be for example a memory, a disk drive, or a USB flash memory, encoding, including or storing instructions, e.g., computer-executable instructions, which when executed by a processor or controller, carry out methods disclosed herein.

The storage medium may include, but is not limited to, any type of disk including, semiconductor devices such as read-only memories (ROMs) and/or random-access memories (RAMs), flash memories, electrically erasable programmable read-only memories (EEPROMs) or any type of media suitable for storing electronic instructions, including programmable storage devices. For example, in some embodiments, memory 120 is a non-transitory machine-readable medium.

A system according to embodiments of the invention may include components such as, but not limited to, a plurality of central processing units (CPUs), a plurality of graphics processing units (GPUs), or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components.

In some embodiments, a system may include or may be, for example, a personal computer, a desktop computer, a laptop computer, a workstation, a server computer, a network device, or any other suitable computing device.

For example, a system as described herein may include one or more facility computing device 100 and one or more remote server computers in active communication with one or more facility computing device 100 such as computing device 100, and in active communication with one or more portable or mobile devices such as smartphones, tablets and the like.

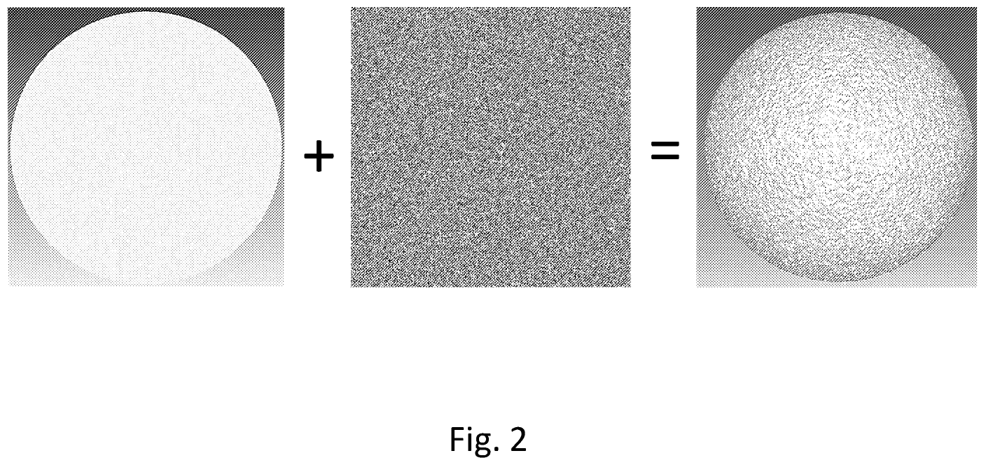

Reference is now made to FIG. 2, which illustrates displacement of a mesh of a 3D object, according to some embodiments of the invention. A texture map (or a bump image) is applied onto a 3D model of the 3D object such that a textured 3D object is generated, where the pixels in the texture map are encoding displacement heights at different locations of the original surface of the 3D model.

The displacement performed to the surface of the 3D model may proceed as a sequence of local update actions, where each update moves one vertex along the vertex related normal in the mesh, in a distance set by the texture map (or a bump image) and limited by for instance maximal displacement and self-intersection constraints.

For example, the highest and lowest values of greyscale pixels are determined, and these pixels may be recolored to be 255 for highest value and 0 for lowest value. The remaining pixels may be accordingly remapped based on the greyscale values. The selected displacement values may be applied to the new texture map.

According to some embodiments, systems and methods are provided for mesh displacement of 3D printing object models. In order to avoid self-intersections for a fixed displacement all over the mesh, the maximal vertex displacement may be calculated such that the displacement may not get closer to any other face or vertex and be limited to an equilibrium point.

For every vertex, the mesh may be updated by moving a proposed vertex position along a normal sized as maximal displacement under constraints of the 3D object. If the closest displacement is smaller than a predefined geometrical limit or constraint, then the position of the proposed vertex may be moved to equilibrium point and repeat checking against all faces.

In some embodiments, internal vertices (e.g., inward to the mesh of the 3D object's mesh) may be moved along a normal, inwards, until the maximal displacement or point of equilibrium is reached. Similarly, external vertices (e.g., outward to the mesh of the 3D object's mesh) may be moved along a normal, outwards, until maximal displacement or point of equilibrium is reached. Since each of the internal and external meshes have the same number of vertices and the same facial orientation as the original 3D mesh, then self-intersections may be prevented.

Reference is now made to FIG. 3, which shows a block diagram of a system 300 for printing a 3D object, according to some embodiments of the invention. In FIG. 3, hardware elements are indicated with a solid line and the direction of arrows indicate a direction of information flow between the hardware elements.

For printing a 3D object 30, dedicated information may be retrieved for a 3D digital model 310 of the 3D object 30. In some embodiments, a processor 301 (e.g., similarly to controller 105 shown in FIG. 1) may receive the 3D digital model 310 of the 3D object 30, for printing with a 3D printing device 302. For example, the processor 301 may receive the 3D digital model 310 as a dedicated file for 3D printing.

The 3D digital model 310 may include data relating to 3D geometry 311 of the 3D object 30 (e.g., density or resolution of the mesh). For example, the 3D digital model 310 may include a data vector with X/Y/Z coordinates and/or data associated with a list of vertices, edges and/or faces of the mesh of the 3D digital model 310. The 3D geometry 311 may further include color data expressed as color per vertex and/or by a 2D (UV) mapping on a texture map.

In some embodiments, the processor 301 may receive a texture map as a 2D displacement map 312 including displacement information. The 2D displacement map 312 may include at least one raster greyscale image. In some embodiments, the 2D displacement map 312 may be image including a series of pixels, where each vertex of the 3D digital model 310 is associated with a pixel of the 2D displacement map 312.

For example, a texture map may include texture information for each point in the 3D digital model, such that texture constraints (e.g., height constraints) are taken into account during the modification of the model.

In some embodiments, the 2D displacement map 312 may be a grayscale image including a maximum grayscale value and a minimum grayscale value, and where each pixel is allocated with a grayscale value between the maximum and minimum grayscale values. For example, the minimum grayscale value may be 0 and the maximum grayscale value may be 255, such that a mid-range grayscale value (e.g., the value of 127) between the maximum grayscale value and the minimum grayscale value may indicate no displacement.

According to some embodiments, the 2D displacement map 312 may be pre-processed by: (i) finding the lowest and highest greyscale value pixel(s); (ii) setting the greyscale value of the lowest greyscale value pixel(s) to a minimum greyscale value; (iii) setting the greyscale value of the highest greyscale value pixel(s) to a maximum greyscale value; and (iv) re-calculating the greyscale value of the remaining pixels according to a proportional rule taking into consideration the maximum and minimum greyscale values.

According to some embodiments, the processor 301 may receive one or more maximal displacement values 321, as a constraint on displacement at each point of the 3D digital model 310. For example, the maximal displacement values 321 may include a constraint on texture height for outward and/or inward displacement, into/outwards from the original mesh.

In some embodiments, the processor 301 may calculate a displacement limit 322 for each vertex of the digital 3D model 310 based on the one or more maximal displacement values 321 (e.g., a displacement limit of 0.5 millimeters). The displacement limit 322 may be calculated such that the topology of the original mesh is maintained.

For example, the one or more maximal displacement values 321 may include a maximal inward displacement value and/or a maximal outward displacement value. The maximal inward displacement value may be between 0 and 1 millimeters and the maximal outward displacement value may be between 0 and 1 millimeters.

In some embodiments, the calculated displacement limit 322 for a vertex of the 3D digital model 310 may include moving the vertex along its normal according to the one or more maximal displacement values 321.

The processor 301 may further receive printing resolution information 303 relating to a 3D printing device 302, that is in communication with the processor 301, in order to adjust the resolution of the 3D digital model 310 to suit the printing resolution information 303 (e.g., considering height constraints). In some embodiments, the printing resolution information 303 of the 3D printing device 302 may be expressed as a number of pixels per unit of distance or as a number of voxels per unit of distance.

For example, the printing resolution 303 may be used to define and/or limit the density of the mesh of the 3D digital model 310.

According to some embodiments, the processor 301 may apply local tessellation (or tiling) on the geometry of the digital 3D model 310 for the displacement. The tessellation may be carried out in accordance with the 2D displacement map 312 and/or with the printing resolution 303, thereby obtaining a tessellated 3D model 320.

For example, the local tessellation may include dividing the mesh into a plurality of triangles, and/or maintaining edge or boundary segmentation between neighbors, and/or filtering out duplicate vertices.

In some embodiments, applying local tessellation may include dividing faces of the geometry of the 3D digital model 310 and increasing a local density of faces, and where at least an edge of each newly generated face is longer than the diagonal of a pixel or voxel defined by the printing resolution 303. In some embodiments, applying local tessellation may include tessellating neighboring faces such that the vertices along their mutual edge match.

According to some embodiments, the processor 301 may apply the displacement information of the 2D displacement map 312 to the tessellated 3D model 320. Applying the displacement information to the tessellated 3D model 320 may be carried out in accordance with the calculated displacement limit 322 relative to each vertex, thereby obtaining a displaced 3D model 330.

In some embodiments, applying the displacement information to the tessellated 3D model 320 by the processor 301 may include displacing a vertex of the tessellated 3D model 320 along the vertex related normal by a distance defined by the 2D displacement map 312 and/or limited by its calculated displacement limit 322. For example, the calculated displacement limit for a vertex of the 3D digital model may be limited to the thickness of a nearby surrounding volume.

Accordingly, the processor 301 may generate a displaced 3D digital model 320 of the 3D object 30. In some embodiments, the processor 301 may calculate for each point in the mesh the result of the displacement (e.g., change of height) and check if the displacement exceeds the maximal displacement values threshold 321.

In some embodiments, the processor 301 may define a plurality of shells of the geometry 311 of the 3D digital model 310 by a bounding box, and/or offsetting at least one of one or more edges, one or more vertices (e.g., a vector of 3D coordinates), or one or more faces (e.g., a vector of triangle indices) of the bounding box, inwardly or outwardly, in the same manner or independently of one another.

In some embodiments, the processor 301 may issue a command to the printing device 302 to print the displaced 3D object on the 3D printing device 302 based on the displaced 3D digital model 320.

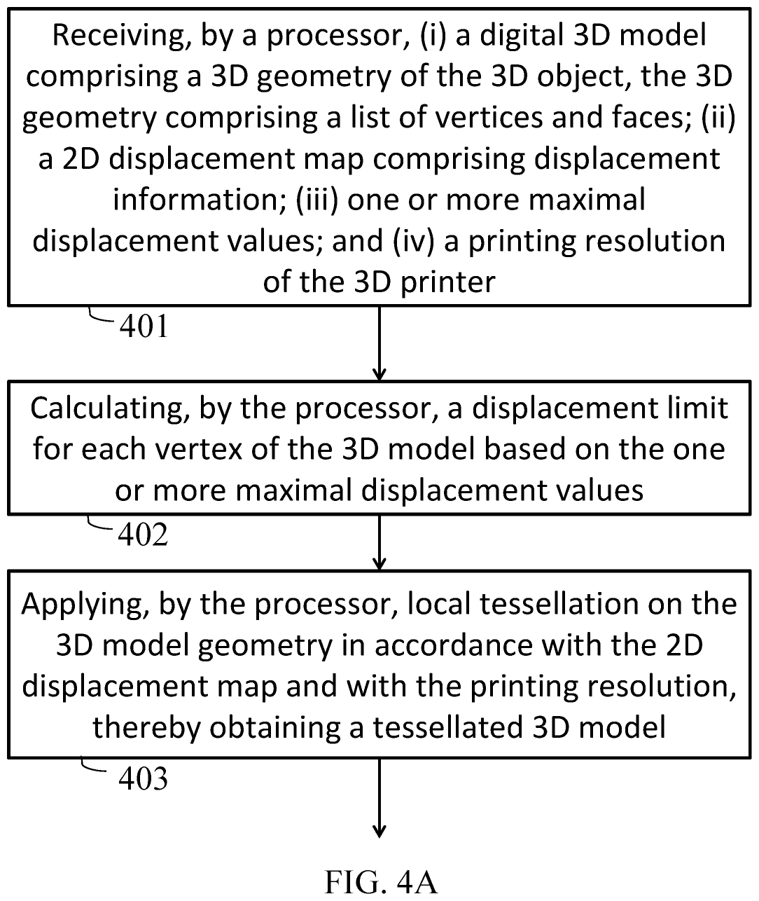

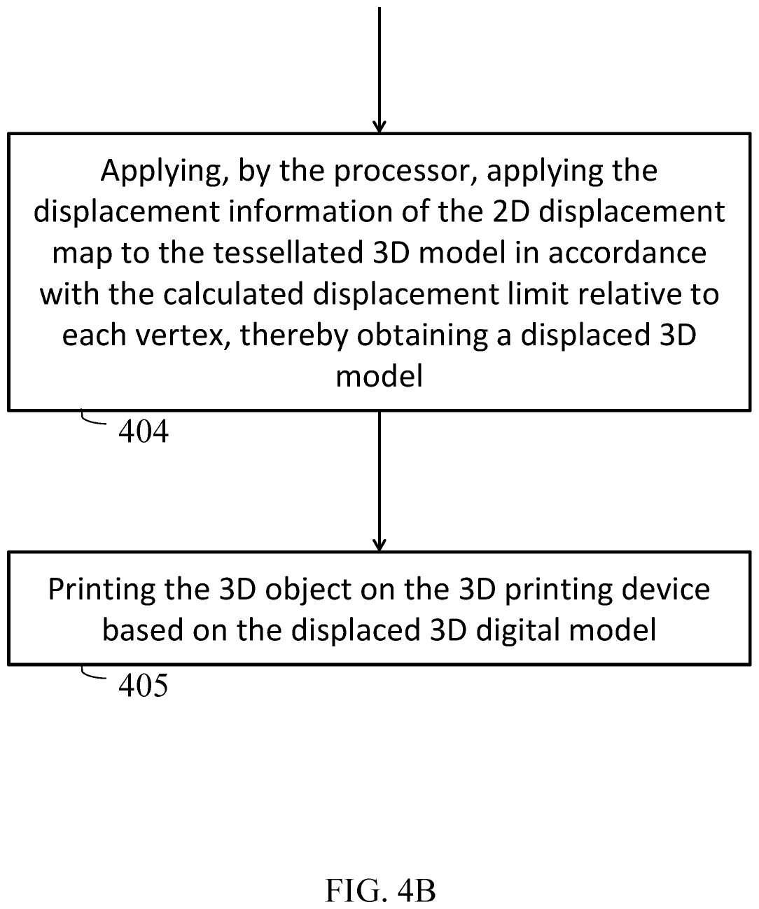

Reference is now made to FIGS. 4A-4B, which show a flowchart of a method of printing a 3D object on a 3D printer, according to some embodiments of the invention.

In Step 401, a digital 3D model including a 3D geometry of the 3D object, may be received (e.g., by the processor), where the 3D geometry may include a list of vertices and faces. A 2D displacement map may be received (e.g., by the processor), where the 2D displacement map includes displacement information. One or more maximal displacement values may be received (e.g., by the processor), and a printing resolution of the 3D printer may be received (e.g., by the processor).

In Step 402, a displacement limit may be calculated (e.g., by the processor) for each vertex of the 3D model based on the one or more maximal displacement values.

In Step 403, local tessellation may be applied (e.g., by the processor) on the 3D model geometry in accordance with the 2D displacement map and with the printing resolution, thereby obtaining a tessellated 3D model.

In Step 404, the displacement information of the 2D displacement map may be applied (e.g., by the processor) to the tessellated 3D model in accordance with the calculated displacement limit relative to each vertex, thereby obtaining a displaced 3D model.

In Step 405, the 3D object may be printed on the 3D printing device based on the displaced 3D digital model.

While certain features of the invention have been illustrated and described herein, many modifications, substitutions, changes, and equivalents may occur to those skilled in the art. It is, therefore, to be understood that the appended claims are intended to cover all such modifications and changes.

Various embodiments have been presented. Each of these embodiments may of course include features from other embodiments presented, and embodiments not specifically described may include various features described herein.

1. A method of printing a 3D object on a 3D printer, the method comprising:
receiving (i) a digital 3D model comprising a 3D geometry of the 3D object, the 3D geometry comprising a list of vertices and faces; (ii) a 2D displacement map comprising displacement information; (iii) one or more maximal displacement values; and (iv) a printing resolution of the 3D printer;
calculating a displacement limit for each vertex of the 3D model based on the one or more maximal displacement values;
applying local tessellation on the 3D model geometry in accordance with the 2D displacement map and with the printing resolution, thereby obtaining a tessellated 3D model;
applying the displacement information of the 2D displacement map to the tessellated 3D model in accordance with the calculated displacement limit relative to each vertex, thereby obtaining a displaced 3D model; and
printing the 3D object with the 3D printer based on the displaced 3D model.

2. The method of claim 1, wherein the 3D geometry further comprises color data expressed as color per vertex or by UV mapping on a texture map.

3. The method of claim 1, wherein the 2D displacement map is an image comprising a series of pixels and wherein each vertex of the 3D model is associated with a pixel of the 2D displacement map.

4. The method of claim 3, wherein the 2D displacement map is a grayscale image comprising a maximum grayscale value and a minimum grayscale value, and wherein each pixel is allocated with a grayscale value comprised between the maximum and minimum grayscale values.

5. The method of claim 4, wherein a mid-range grayscale value between the maximum grayscale value and the minimum grayscale value indicates no displacement.

6. The method of claim 4, wherein the minimum grayscale value is 0 and the maximum grayscale value is 255.

7. The method of claim 6, wherein a grayscale value of 127 indicates no displacement.

8. The method of claim 3, wherein the 2D displacement map is pre-processed by (i) finding the lowest and highest greyscale value pixel(s); (ii) setting the greyscale value of the lowest greyscale value pixel(s) to a minimum greyscale value; (iii) setting the greyscale value of the highest greyscale value pixel(s) to a maximum greyscale value; and (iv) re-calculating the greyscale value of the remaining pixels according to a proportional rule taking into consideration the maximum and minimum greyscale values.

9. The method of claim 8, wherein the minimum greyscale value is 0 and the maximum greyscale value is 255.

10. The method of claim 1, wherein the one or more maximal displacement values comprises a maximal inward displacement value and a maximal outward displacement value.

11. The method of claim 10, wherein the maximal inward displacement value is of between 0 and 1 mm and the maximal outward displacement value is of between 0 and 1 mm.

12. The method of claim 1, wherein the printing resolution is provided as a number of pixels per unit of distance or a number of voxel per unit of distance.

13. The method of claim 1, wherein applying local tessellation comprises dividing faces of the 3D model geometry and increasing a local density of faces, and wherein at least an edge of each newly generated faces is longer than the diagonal of a pixel or voxel defined by the printing resolution.

14. The method of claim 1, wherein calculating a displacement limit for a vertex of the 3D model comprises moving the vertex along its normal according to the one or more maximal displacement values.

15. The method of claim 14, wherein the calculated displacement limit for a vertex of the 3D digital model is limited to the thickness of a nearby surrounding volume.

16. The method of claim 1, wherein applying the displacement information to the tessellated 3D model comprises displacing a vertex of the tessellated 3D model along the vertex related normal by a distance defined by the 2D displacement map and limited by its calculated displacement limit.

17. The method of claim 1, wherein local tessellating comprises tessellating neighboring faces such that the vertices along their mutual edge match.

18. A system for printing a 3D object, the system comprising:
a 3D printing device, comprising a printing resolution; and
a processor, in communication with the 3D printing device, wherein the processor is configured to:
receive (i) a digital 3D model comprising a 3D geometry of the 3D object, the 3D geometry comprising a list of vertices and faces;
(ii) a 2D displacement map comprising displacement information; (iii) one or more maximal displacement values; and
(iv) the printing resolution;
calculate a displacement limit for each vertex of the 3D model based on the one or more maximal displacement values;
apply local tessellation on the 3D model geometry in accordance with the 2D displacement map and with the printing resolution, thereby obtaining a tessellated 3D model;
apply the displacement information of the 2D displacement map to the tessellated 3D model in accordance with the calculated displacement limit relative to each vertex, thereby obtaining a displaced 3D model; and
print the 3D object with the 3D printer based on the displaced 3D model.

19. The system of claim 18, wherein the 2D displacement map is pre-processed by (i) finding the lowest and highest greyscale value pixel(s), (ii) setting the greyscale value of the lowest greyscale value pixel(s) to a minimum greyscale value, (iii) setting the greyscale value of the highest greyscale value pixel(s) to a maximum greyscale value, and (iv) re-calculating the greyscale value of the remaining pixels according to a proportional rule taking into consideration the maximum and minimum greyscale values.

20. The system of claim 18, wherein calculation of a displacement limit for a vertex of the 3D model comprises moving the vertex along its normal according to the one or more maximal displacement values.
